(19) United States
(12) Patent Application Publication
(10) Pub. No.: US 2026/0351960 A1
(43) Pub. Date: Nov. 5, 2026

(54) A CURRENT LIMITER CIRCUIT AND A METHOD OF CONTROLLING CURRENT BETWEEN A POWER SUPPLY SOURCE AND A POWER SUPPLY CAPACITOR OF A POWER SUPPLY

(71) Applicant: Zerro Power Systems Pte Ltd, Singapore (SG)

(72) Inventors: Sehat SUTARDJA, Singapore (SG); Krishnamoorthy RAVISHANKER, Singapore (SG)

(21) Appl. No.: 18/997,627

(22) PCT Filed: Jul. 21, 2023
(86) PCT No.: PCT/SG2023/050509

§ 371 Date: Jan. 22, 2025

(30) Foreign Application Priority Data
Jul. 22, 2022 (SG) 10202250553J

(51) Int. Cl. H02H 9/02

(52) U.S. Cl. CPC H02H 9/025

(57) ABSTRACT

There is provided a current limiter circuit and a method of controlling current between a power supply source and a power supply capacitor of a power supply, the circuit comprising an input node connectable to the power supply source; an output node connectable to the power supply capacitor; a first MOSFET transistor and a second MOSFET transistor coupled in series between the input node and the output node; a current limiter element coupled in parallel with the second MOSFET transistor; a controller comprising a controller output for controlling operations of the first and second MOSFET transistors; and a delay circuit coupled to the controller output, said delay circuit for providing a time delay to signals at the controller output; wherein during powering up of the power supply source, the controller is configured to switch on the first MOSFET transistor such that current flows between the input node and the output node via the current limiter element; and switch on the second MOSFET transistor after the time delay, such that current flows between the input node and the output node bypassing the current limiter element.

### TECHNICAL FIELD

The present disclosure relates broadly to a current limiter circuit and a method of controlling current between a power supply source and a power supply capacitor of a power supply.

### BACKGROUND

In a power supply system, an inrush current refers to the high surge of current that occurs for a brief period when the power supply system is initially turned on or when a load is connected to it. This phenomenon is particularly prominent in power supply systems that utilize capacitors. When the power supply system is turned on, the capacitors in the system are initially discharged. As power is applied, these capacitors start to charge up almost instantaneously. During this charging period, a high inrush current may flow into the capacitors as they rapidly draw current from a power supply source to charge up.

An inrush current can cause a variety of problems. For example, an inrush current can cause damage to wires and tracks of printed circuit boards (PCB). An inrush current can also cause Electro Magnetic Interference (EMI). An inrush current can also damage passive components like capacitors and resistors. An inrush current can also reduce the reliability of the power supply system. An inrush current can also cause damage to the power supply source and cause instability or malfunction of the power supply source and/or the power supply system.

To mitigate the effects of inrush current, various techniques can be employed in power supply systems, including the use of inrush current limiters. However, the inrush current limiters that are currently known in the art have limitations such as limited effectiveness for large inrush currents, delayed power-up, increased voltage drop, and additional power dissipation.

In addition, in a power supply system, reverse voltage occurs when the polarity of the voltage applied is opposite to the expected or desired polarity. Reverse voltage can also cause a variety of problems such as component damage, incorrect operation, overheating or fire hazard and system instability.

To prevent or mitigate the effects of reverse voltage, various protective measures can be implemented, such as using diodes for reverse voltage protection. Typically, a reverse protection diode is used on the output of a power supply to protect the power supply from damage due to reverse voltage, e.g., by adding a diode or Schottky diode in series with the power supply. However, reverse protection techniques that are currently known in the art have limitations such as voltage drop, delayed response, complexity and relatively high cost. For example, one disadvantage with Schottky diode is that its series resistance is high and hence this leads to dissipation of power, thereby lowering the efficiency of a power supply system.

Thus, there is a need for a current limiter circuit and a method of controlling current between a power supply source and a power supply capacitor of a power supply that seek to address or alleviate at least one of the above problems.

### SUMMARY

In accordance with a first aspect of the present disclosure, there is provided a current limiter circuit for controlling current between a power supply source and a power supply capacitor of a power supply, the circuit comprising an input node connectable to the power supply source; an output node connectable to the power supply capacitor; a first MOSFET transistor and a second MOSFET transistor coupled in series between the input node and the output node; a current limiter element coupled in parallel with the second MOSFET transistor; a controller comprising a controller output for controlling operations of the first and second MOSFET transistors; and a delay circuit coupled to the controller output, said delay circuit for providing a time delay to signals at the controller output; wherein during powering up of the power supply source, the controller is configured to switch on the first MOSFET transistor such that current flows between the input node and the output node via the current limiter element; and switch on the second MOSFET transistor after the time delay, such that current flows between the input node and the output node bypassing the current limiter element.

In the current limiter circuit of the present disclosure, prior to switching on the first MOSFET transistor, the controller may be further configured to maintain the first MOSFET transistor and the second MOSFET transistor in respective off states for an initial time period, such that current flows from a body diode of the first MOSFET transistor to the output node via the current limiter element.

In the current limiter circuit of the present disclosure, an input terminal of the first MOSFET transistor may be coupled to the input node; an output terminal of the first MOSFET transistor may be coupled to the input terminal of the second MOSFET transistor; and an output terminal of the second MOSFET transistor may be coupled to the output node.

In the current limiter circuit of the present disclosure, the current limiter element may comprise a resistor connected in parallel with the input and output terminals of the second MOSFET transistor.

In the current limiter circuit of the present disclosure, the controller may comprise a controller input coupled to the output node; and the controller output may be coupled to respective gate terminals of the first and second MOSFET transistors.

In the current limiter circuit of the present disclosure, the delay circuit may comprise an RC delay element, said RC delay element comprising a delay resistor coupled between the controller output and the gate terminal of the second MOSFET transistor; and a capacitor coupled between the gate terminal of the second MOSFET transistor and the input terminal of the second MOSFET transistor.

In the current limiter circuit of the present disclosure, the time delay may be a time period for the power supply capacitor to be sufficiently charged when current flows through the current limiter element.

In the current limiter circuit of the present disclosure, the first and second MOSFET transistors may be PMOS transistors.

In accordance with a second aspect of the present disclosure, there is provided a method of controlling current between a power supply source at an input node of a current limiter circuit and a power supply capacitor of a power supply at an output node of the current limiter circuit, the method comprising, providing a first MOSFET transistor and a second MOSFET transistor coupled in series between the input node and the output node; providing a controller comprising an output terminal for controlling the first and second MOSFET transistors; providing a current limiter element coupled in parallel with the second MOSFET transistor; providing a delay circuit for delaying switching on of the second MOSFET transistor for a time period after the first MOSFET transistor is switched on; switching on the first MOSFET transistor during powering up of the power supply source, such that current flows between the input node and the output node via the current limiter element; and switching on the second MOSFET transistor after the time period, such that current flows between the input node and the output node, bypassing the current limiter element.

The method may further comprise, prior to switching on the first MOSFET transistor, maintaining the first MOSFET transistor and the second MOSFET transistor in respective off states for an initial time period, such that current flows from a body diode of the first MOSFET transistor to the output node via the current limiter element.

The step of providing the first MOSFET transistor and the second MOSFET transistor may comprise, coupling an input terminal of the first MOSFET transistor to the input node; coupling an output terminal of the first MOSFET transistor to the input terminal of the second MOSFET transistor; and coupling an output terminal of the second MOSFET transistor to the output node.

The step of providing the current limiter element may comprise connecting a resistor in parallel with the input and output terminals of the second MOSFET transistor.

The step of providing the controller may comprise coupling an input terminal of the controller to the output node; and coupling the output terminal of the controller to respective gate terminals of the first and second MOSFET transistors.

The step of providing the delay circuit may comprise providing a delay resistor coupled between the output terminal of the controller and the gate terminal of the second MOSFET transistor; and providing a capacitor coupled between the gate terminal of the second MOSFET transistor and the input terminal of the second MOSFET transistor.

In the method of the present disclosure, the time delay may be a time period for the power supply capacitor to be sufficiently charged when current flows through the current limiter element.

In the method of the present disclosure, the first and second MOSFET transistors may be PMOS transistors.

### BRIEF DESCRIPTION OF THE DRAWINGS

Exemplary embodiments of the invention will be better understood and readily apparent to one of ordinary skill in the art from the following written description, by way of example only, and in conjunction with the drawings, in which:

FIG. 1 is a schematic block diagram of a current limiter circuit for controlling current between a power supply source and a power supply capacitor of a power supply in an example embodiment.

FIG. 2 is a circuit diagram of a current limiter circuit for controlling current between a power supply source and a power supply capacitor of a power supply in an example embodiment.

FIG. 3A is a graph showing a current profile at the resistor R3 in the current limiter circuit of FIG. 2 in an example embodiment.

FIG. 3B is a graph showing voltage profiles taken at different locations in the current limiter circuit of FIG. 2 in the example embodiment.

FIG. 4 is a schematic flow chart for illustrating a method of controlling current between a power supply source at an input node of a current limiter circuit and a power supply capacitor of a power supply at an output node of the current limiter circuit in an example embodiment.

### DETAILED DESCRIPTION

Example, non-limiting embodiments may provide a current limiter circuit and a method of controlling current between a power supply source and a power supply capacitor of a power supply.

In various embodiments, a power supply or power supply system may further comprise at least a power supply source and a power supply capacitor.

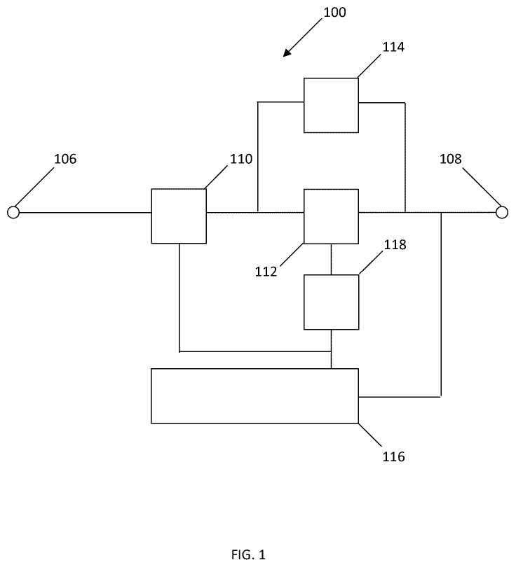

FIG. 1 is a schematic block diagram of a current limiter circuit 100 for controlling current between a power supply source and a power supply capacitor of a power supply in an example embodiment.

In the example embodiment, the current limiter circuit 100 comprises an input node 106 connectable to the power supply source. The current limiter circuit 100 further comprises an output node 108 connectable to the power supply capacitor. The current limiter circuit 100 further comprises a first Metal Oxide Semiconductor Field Effect Transistor (MOSFET) transistor 110 and a second MOSFET transistor 112 coupled in series between the input node 106 and the output node 108. The current limiter circuit 100 further comprises a current limiter element 114 coupled in parallel with the second MOSFET transistor 112. The current limiter circuit 100 further comprises a controller 116 comprising a controller output/controller output terminal for controlling operations of the first and second MOSFET transistors 110, 112. The current limiter circuit 100 further comprises a delay circuit 118 coupled to the controller output, said delay circuit 118 for providing a time delay to signals at the controller output.

In the example embodiment, the current limiter element 114 may be a component or circuitry that is configured to restrict or control the amount of current flowing through the system. For example, the current limiter element 114 may be a resistor, e.g., current-limiting resistor having a resistance value chosen to limit the current to a safe level.

In the example embodiment, the delay circuit 118 is configured to provide a time delay (i.e., a controlled time delay) to signals at the controller output. The time delay is a time period or time interval for the power supply capacitor to be sufficiently charged when current flows through the current limiter element 114. For example, the time delay circuit 118 may be an RC delay circuit which uses a combination of a resistor and a capacitor to create a time delay. In such an RC delay circuit, the time delay may be determined by the values of the resistor and capacitor.

In the example embodiment, the time it takes to charge a power supply capacitor in a power supply system may depend on various factors, including the capacitance value (C) of the power supply capacitor, the charging current (I), and any resistance (R) in the charging circuit. The charging time can be estimated using the formula:

t=(C*V)/I
Where:
t is the charging time in seconds
C is the capacitance of the power supply capacitor in farads
V is the voltage across the power supply capacitor in volts
I is the charging current in amperes

It will be appreciated that the above formula assumes an ideal charging circuit with a constant charging current. In practice, the charging current may vary over time due to factors such as the internal resistance of the power supply, the power supply capacitor's equivalent series resistance (ESR), and any current-limiting components in the circuit. In addition, the charging time may be affected by the initial voltage across the power supply capacitor. If the power supply capacitor is initially discharged, the charging time will be longer compared to a scenario where the power supply capacitor is partially charged.

In the example embodiment, during powering up of the power supply source, the controller 116 is configured to switch on the first MOSFET transistor 110 such that current flows between the input node 106 and the output node 108 via the current limiter element 114; and switch on the second MOSFET transistor 112 after the time delay, such that current flows between the input node 106 (connected to the power supply source) and the output node 108 (connected to the power supply capacitor) bypassing the current limiter element 114.

In the example embodiment, prior to switching on the first MOSFET transistor 110, the controller 116 may be configured to maintain the first MOSFET transistor 110 and the second MOSFET transistor 112 in respective off states for an initial time period, such that current flows from the first MOSFET transistor 110 to the output node 108 via the current limiter element 114.

In the example embodiment, the current limiter circuit 100 may advantageously limit an inrush current and provide protection from reverse supply voltage in a power supply system. The current limiter circuit 100 may advantageously protect the power supply and connected devices from excessive current, which can lead to equipment damage or failure, fire hazards, or safety risks. The current limiter circuit 100 may advantageously ensure the stability and reliability of the power supply system by maintaining the current within safe operating limits.

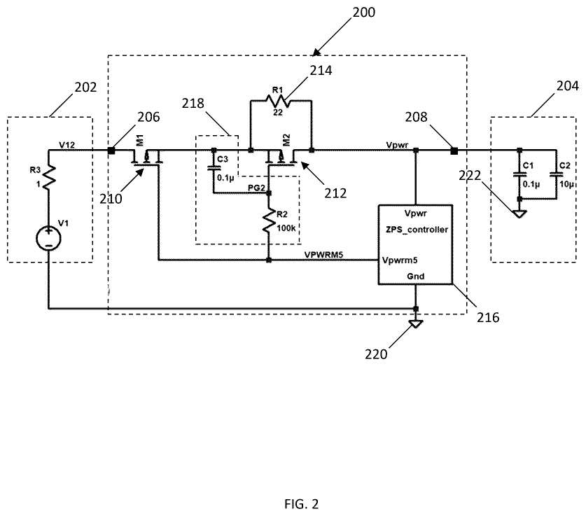

FIG. 2 is a circuit diagram of a current limiter circuit 200 for controlling current between a power supply source 202 and a power supply capacitor 204 of a power supply in an example embodiment.

In the example embodiment, the current limiter circuit 200 comprises an input node 206 connectable to the power supply source 202. The input node 206 is configured to receive a supply voltage. The power supply source 202 comprises a supply voltage V1 connected in series with a resistor R3. The resistor R3 is connected between the positive terminal of the supply voltage V1 and the input node 206. The resistor R3, e.g., 1 Ω, may be representative of the internal resistance of the source V1.

In the example embodiment, the current limiter circuit 200 further comprises an output node 208 connectable to the power supply capacitor 204. The power supply capacitor 204 comprises a first capacitor C1 and a second capacitor C2 connected in parallel. The first capacitor C1 has a capacitance of 0.1 μF and the second capacitor C2 has a capacitance of 10 μF. It will be appreciated that the capacitances of the first capacitor C1 and the second capacitor C2 are not limited as such, and other combinations of capacitances may be used. Further, it will be appreciated that the larger the capacitance of the capacitors C1 and C2, the higher the inrush current.

As shown in FIG. 2, the input node 206 of the current limiter circuit 200 is connected to the power supply source 202 and the output node 208 of the current limiter circuit 200 is connected to the power supply capacitor 204. The power supply source 202 is connected to a first cable termination point/ground 220. The power supply capacitor 204 is connected to a second cable termination point/ground 222.

In the example embodiment, the current limiter circuit 200 further comprises a first MOSFET transistor 210 and a second MOSFET transistor 212 coupled in series between the input node 206 and the output node 208. The first MOSFET transistor 210 and second MOSFET transistor 212 are P-channel (PMOS) MOSFETs M1 and M2, respectively. The first MOSFET transistor 210 and second MOSFET transistor 212 each comprises an input terminal, an output terminal, and a gate terminal. The input terminal of the first MOSFET transistor 210 is coupled to the input node 206. The output terminal of the first MOSFET transistor 210 is coupled to the input terminal of the second MOSFET transistor 212. The output terminal of the second MOSFET transistor 212 is coupled to the output node 208.

In the example embodiment, by adding the first MOSFET transistor 210 and controlling the gate terminal of the first MOSFET transistor 210, the power dissipated in the first and second MOSFET transistors 210, 212 can be lowered, thereby improving overall efficiency of the power supply system. When the first MOSFET transistor 210 is turned off, a body diode of the first MOSFET transistor 210 provides reverse protection to the power supply source 202. Such an arrangement may provide an improvement over typical reverse protection techniques that are done by adding a diode or Schottky diode in series with a power supply. For example, one disadvantage with Schottky diode is that its series resistance is high and hence dissipates power, thereby lowering the efficiency of the system. In the example embodiment, the current limiter circuit 200 further comprises a current limiter element 214 coupled in parallel with the second MOSFET transistor 212. As shown in FIG. 2, the current limiter element 214 comprises a resistor R1 connected in parallel with the input and output terminals of the second MOSFET transistor 212. The resistor R1 may have a resistance value chosen to limit the current to a safe level. As mentioned, it will be appreciated that the larger the capacitance values of the capacitors C1 and C2, the higher the inrush current. As such, the resistance value of resistor R1 used is based on the capacitance of the capacitors C1 and C2. In the example embodiment if V1 is 12 V and the first capacitor C1 has a capacitance of 0.1 μF and the second capacitor C2 has a capacitance of 10 μF, a typical value for the resistor R1 may be in the order of tens of ohms, e.g., falling in the range of from about 10 Ω to about 50 Ω. For example, the R1 value in the current limiter circuit 200 may be about 22 Ω.

In the example embodiment, the current limiter circuit 200 further comprises a controller 216 comprising a controller output/controller output terminal Vpwrm5 for controlling operations of the first MOSFET transistor 210 and second MOSFET transistor 212. The controller 216 further comprises a controller input/controller input terminal Vpwr coupled to the output node 208. The controller output Vpwrm5 is coupled to respective gate terminals of the first MOSFET transistor 210 and second MOSFET transistor 212. The controller 216 further comprises a ground terminal Gnd coupled to the negative terminal of the supply voltage V1. The controller 216 is configured to limit inrush current by controlling the first MOSFET transistor 210 and second MOSFET transistor 212 through the controller output Vpwrm5.

In the example embodiment, the current limiter circuit 200 further comprises a delay circuit 218 coupled to the controller output Vpwrm5. The delay circuit 218 is configured to provide a time delay to signals at the controller output Vpwrm5. The delay circuit 218 comprises an RC delay element, said RC delay element comprising a delay resistor R2, e.g., having a resistance value of 100 kΩ, coupled between the controller output Vpwrm5 and the gate terminal of the second MOSFET transistor 212; and a capacitor C3, e.g., having a capacitance of 0.1 μF, coupled between the gate terminal of the second MOSFET transistor 212 and the input terminal of the second MOSFET transistor 212. The time delay is a time period for the supply capacitor 204 to be sufficiently charged when current flows through the current limiter element 214. It will be appreciated that inrush current reduces as the capacitor charges and the capacitor voltage increases. The delay circuit 218 is configured to provide a time delay which allows for the second MOSFET transistor 212 to be turned on when the voltages of capacitors C1 and C2 are close to the input supply voltage V1. In the example embodiment, the delay circuit 218 allows for the second MOSFET transistor 212 to be turned on, when the voltages of capacitors C1 and C2 are in the range of 90-95% of the input supply voltage V1.

In the example embodiment, in the RC delay element of the delay circuit 218, the capacitor C3 charges and discharges through the delay resistor R2, and the time it takes for the capacitor C3 voltage to reach a certain threshold or percentage of its final value determines the time delay. The time delay can be calculated using the following formula:

T=R*C
Where:
T is the time delay in seconds(s)
R is the resistance in ohms (Ω)
C is the capacitance in farads (F)

The product of the resistance and capacitance gives the time constant (RC) of the circuit. The time constant represents the time it takes for the capacitor voltage to reach approximately 63.2% (1−1/e) of its final value during charging or discharging. It will be appreciated that the above formula provides an approximation, assuming an ideal circuit without any other factors influencing the time delay. In practice, factors such as leakage currents, internal resistance, and non-ideal characteristics of components can affect the actual time delay.

In the example embodiment, during initial powering up of the power supply source 202, the controller 216 is configured to maintain the first MOSFET transistor 210 and the second MOSFET transistor 212 in respective off states for an initial time period, such that current flows from a body diode of the first MOSFET transistor 210 to the output node 208 and to the power supply capacitor 204 via the current limiter element 214. That is, as the input voltage Vpwr at the controller 216 ramps up during power up, the controller output Vpwrm5 is configured to be kept/or maintained at the same voltage level as the controller input Vpwr initially. During this initial stage, Vpwrm5 is below the threshold voltage of both the first MOSFET transistor 210 and the second MOSFET transistor 212, thereby keeping the first MOSFET transistor 210 and the second MOSFET transistor 212 in their respective off states. The first capacitor C1 and second capacitor C2 of the power supply capacitor 204 are charged by the body diode of the first MOSFET transistor 210 together with the current limiter element 214, wherein the current limiter element 214 limits the current flow from the first MOSFET transistor 210 to the power supply capacitor 204.

In the example embodiment, during powering up of the power supply source 202 and after the initial stage, the controller 216 is configured to switch on the first MOSFET transistor 210 such that current flows between the input node 206 and the output node 208 and subsequently to the power supply capacitor 204 via the current limiter element 214; and switch on the second MOSFET transistor 212 after the time delay, such that current flows between the power supply source 202 and the power supply capacitor 204 bypassing the current limiter element 214.

That is, after the initial stage, the controller 216 turns on the first MOSFET transistor 210 as the controller output Vpwrm5 exceeds the threshold voltage of the first MOSFET transistor 210, and the first capacitor C1 and second capacitor C2 of the power supply capacitor 204 are now charged by the power supply source 202 via the first MOSFET transistor 210 and the current limiter element 214, with the second MOSFET transistor 212 remaining in the off state. The current flow from the first MOSFET transistor 210 to the power supply capacitor 204 is still limited by the current limiter element 214.

The second MOSFET transistor 212 is turned on (i.e., the voltage at the gate of the second MOSFET transistor 212 exceeds the threshold voltage) after the time delay, said time delay dependent on the values of the delay resistor R2 and the capacitor C3 of the delay circuit 218. The values of the delay resistor R2 and the capacitor C3 are chosen such that the second MOSFET transistor 212 turns on only after the first capacitor C1 and second capacitor C2 are charged through the current limiter element 214. When the second MOSFET transistor 212 is turned on, there is no inrush current as the first capacitor C1 and second capacitor C2 are already charged. The controller 216 commences its normal functioning only after charging of the first capacitor C1 and second capacitor C2 is complete.

In the example embodiment, the first and second MOSFET transistors 210, 212 are PMOS transistors.

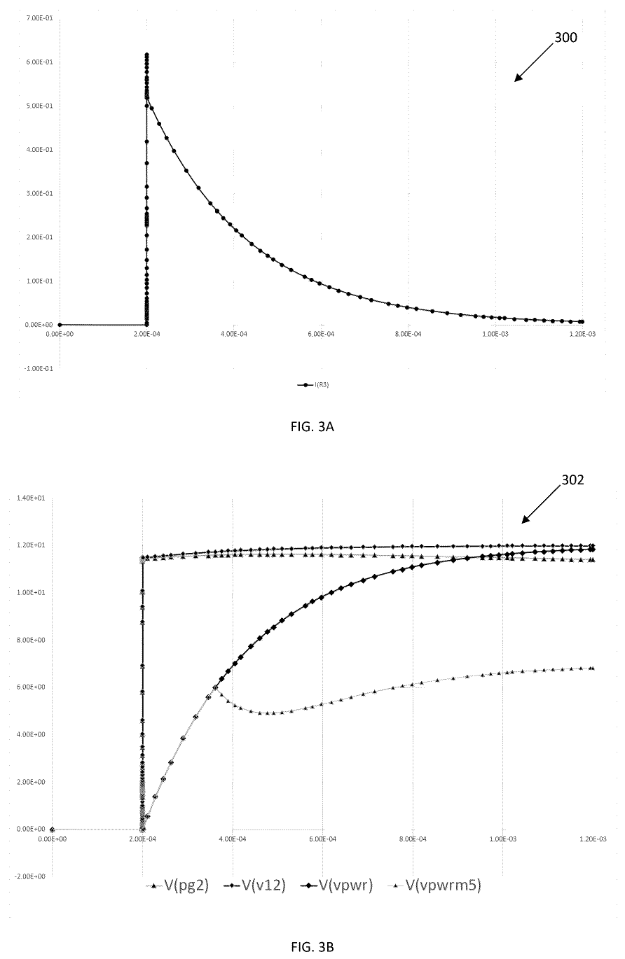

FIG. 3A is a graph 300 showing a current profile at the resistor R3 in the current limiter circuit 200 of FIG. 2 in an example embodiment. The vertical axis represents current in amperes and the horizontal axis represents time in seconds. FIG. 3B is a graph 302 showing voltage profiles taken at different locations in the current limiter circuit 200 of FIG. 2 in the example embodiment. The vertical axis represents voltage in volts and the horizontal axis represents time in seconds. The different locations are the input node 206 (see V(v12)), the controller input Vpwr (see V(vpwr)), the controller output Vpwrm5 (see V(vpwrm5)), and node between the delay resistor R2 and capacitor C3 in the delay circuit 218 (see V(pg2)). V(v12) is the input power supply that is turned on at 200 us from 0 to 12 V. It will be appreciated that the input power supply may be turned on at a different time point in other example embodiments. V(pg2) is the voltage that controls the second MOSFET transistor 212 (or M2). When the difference between V(v12) and V(pg2) is small, M2 remains in the off state. In this case, M2 is in the off state for the whole period of the graph, so that the inrush current shown in FIG. 3A is almost zero. When the difference between V(vpwrm5) and V(v12) is small, the first MOSFET transistor 210 (or M1) remains in the off state. When the difference is sufficiently larger, M1 turns ON. V(vpwr) is the voltage supplied to the controller 216. V(vpwr) is slowly increasing, based on the state of M1 and M2. The peak current is limited by the resistor R3. In this case, the peak current is limited to be 500 mA.

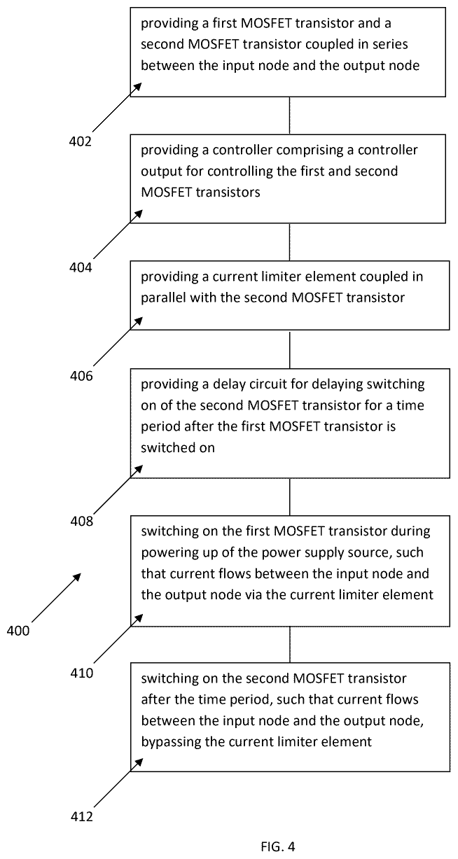

FIG. 4 is a schematic flow chart 400 for illustrating a method of controlling current between a power supply source at an input node of a current limiter circuit and a power supply capacitor of a power supply at an output node of the current limiter circuit in an example embodiment. At step 402, a first MOSFET transistor and a second MOSFET transistor provided coupled in series between the input node and the output node. At step 404, a controller comprising an output terminal is provided, said controller configured for controlling the first and second MOSFET transistors. At step 406, a current limiter element is provided coupled in parallel with the second MOSFET transistor. At step 408, a delay circuit is provided for delaying switching on of the second MOSFET transistor for a time period after the first MOSFET transistor is switched on. At step 410, the first MOSFET transistor is switched on during powering up of the power supply source, such that current flows between the input node and the output node via the current limiter element. At step 412, the second MOSFET transistor is switched on after the time period, such that current flows between the power supply source and the power supply capacitor, bypassing the current limiter element. In the example embodiment, the method may further comprise, prior to switching on the first MOSFET transistor, maintaining the first MOSFET transistor and the second MOSFET transistor in respective off states for an initial time period, such that current flows from the first MOSFET transistor to the output node via the current limiter element. In the example embodiment, the step of providing the first MOSFET transistor and the second MOSFET transistor may comprise, coupling an input terminal of the first MOSFET transistor to the input node; coupling an output terminal of the first MOSFET transistor to the input terminal of the second MOSFET transistor; and coupling an output terminal of the second MOSFET transistor to the output node. In the example embodiment, the step of providing the current limiter element may comprise connecting a resistor in parallel with the input and output terminals of the second MOSFET transistor. In the example embodiment, the step of providing the controller may comprise coupling an input terminal of the controller to the output node; and coupling the output terminal of the controller to respective gate terminals of the first and second MOSFET transistors. In the example embodiment, the step of providing the delay circuit may comprise providing a delay resistor coupled between the output terminal of the controller and the gate terminal of the second MOSFET transistor; and providing a capacitor coupled between the gate terminal of the second MOSFET transistor and the input terminal of the second MOSFET transistor. In the example embodiment, the time delay may be a time period for the supply capacitor to be sufficiently charged when current flows through the current limiter element. In the example embodiment, the first and second MOSFET transistors may be PMOS transistors. In the example embodiment, the first and second MOSFET transistors may be NMOS transistors, and the method may further comprise providing a charge pump for generating an output signal at the output terminal of the controller, said output signal having a voltage higher than a supply voltage of the controller. In the example embodiment, the range of the output signal may be limited to the operating range of the second MOSFET transistor.

The terms “coupled” or “connected” as used in this description are intended to cover both directly connected or connected through one or more intermediate means, unless otherwise stated.

The description herein may be, in certain portions, explicitly or implicitly described as algorithms and/or functional operations that operate on data within a computer memory or an electronic circuit. These algorithmic descriptions and/or functional operations are usually used by those skilled in the information/data processing arts for efficient description. An algorithm is generally relating to a self-consistent sequence of steps leading to a desired result. The algorithmic steps can include physical manipulations of physical quantities, such as electrical, magnetic or optical signals capable of being stored, transmitted, transferred, combined, compared, and otherwise manipulated.

Further, unless specifically stated otherwise, and would ordinarily be apparent from the following, a person skilled in the art will appreciate that throughout the present specification, discussions utilizing terms such as “scanning”, “calculating”, “determining”, “replacing”, “generating”, “initializing”, “outputting”, and the like, refer to action and processes of an instructing processor/computer system, or similar electronic circuit/device/component, that manipulates/processes and transforms data represented as physical quantities within the described system into other data similarly represented as physical quantities within the system or other information storage, transmission or display devices etc.

The description also discloses relevant device/apparatus for performing the steps of the described methods. Such apparatus may be specifically constructed for the purposes of the methods, or may comprise a general purpose computer/processor or other device selectively activated or reconfigured by a computer program stored in a storage member. The algorithms and displays described herein are not inherently related to any particular computer or other apparatus. It is understood that general purpose devices/machines may be used in accordance with the teachings herein. Alternatively, the construction of a specialized device/apparatus to perform the method steps may be desired.

In addition, it is submitted that the description also implicitly covers a computer program, in that it would be clear that the steps of the methods described herein may be put into effect by computer code. It will be appreciated that a large variety of programming languages and coding can be used to implement the teachings of the description herein. Moreover, the computer program if applicable is not limited to any particular control flow and can use different control flows without departing from the scope of the invention.

Furthermore, one or more of the steps of the computer program if applicable may be performed in parallel and/or sequentially. Such a computer program if applicable may be stored on any computer readable medium. The computer readable medium may include storage devices such as magnetic or optical disks, memory chips, or other storage devices suitable for interfacing with a suitable reader/general purpose computer. In such instances, the computer readable storage medium is non-transitory. Such storage medium also covers all computer-readable media e.g. medium that stores data only for short periods of time and/or only in the presence of power, such as register memory, processor cache and Random Access Memory (RAM) and the like. The computer readable medium may even include a wired medium such as exemplified in the Internet system, or wireless medium such as exemplified in bluetooth technology. The computer program when loaded and executed on a suitable reader effectively results in an apparatus that can implement the steps of the described methods.

The example embodiments may also be implemented as hardware modules. A module is a functional hardware unit designed for use with other components or modules. For example, a module may be implemented using digital or discrete electronic components, or it can form a portion of an entire electronic circuit such as an Application Specific Integrated Circuit (ASIC). A person skilled in the art will understand that the example embodiments can also be implemented as a combination of hardware and software modules.

Additionally, when describing some embodiments, the disclosure may have disclosed a method and/or process as a particular sequence of steps. However, unless otherwise required, it will be appreciated the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. For an example, when “comprising” is used, reference to a “one” feature is also intended to be a reference to “at least one” of that feature. Terms such as “consisting”, “consist”, and the like, may, in the appropriate context, be considered as a subset of terms such as “comprising”, “comprise”, and the like. Therefore, in embodiments disclosed herein using the terms such as “comprising”, “comprise”, and the like, it will be appreciated that these embodiments provide teaching for corresponding embodiments using terms such as “consisting”, “consist”, and the like. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. The intention of the above specific disclosure is applicable to any depth/breadth of a range.

It will be appreciated by a person skilled in the art that other variations and/or modifications may be made to the specific embodiments without departing from the scope of the invention as broadly described. For example, in the description herein, features of different exemplary embodiments may be mixed, combined, interchanged, incorporated, adopted, modified, included etc. or the like across different exemplary embodiments. The present embodiments are, therefore, to be considered in all respects to be illustrative and not restrictive.

1. A current limiter circuit for controlling current between a power supply source and a power supply capacitor of a power supply, the circuit comprising
an input node connectable to the power supply source;
an output node connectable to the power supply capacitor;
a first MOSFET transistor and a second MOSFET transistor coupled in series between the input node and the output node;
a current limiter element coupled in parallel with the second MOSFET transistor;
a controller comprising a controller output for controlling operations of the first and second MOSFET transistors; and
a delay circuit coupled to the controller output, said delay circuit for providing a time delay to signals at the controller output;
wherein during powering up of the power supply source, the controller is configured to
switch on the first MOSFET transistor such that current flows between the input node and the output node via the current limiter element; and
switch on the second MOSFET transistor after the time delay, such that current flows between the input node and the output node bypassing the current limiter element.

2. The current limiter circuit of claim 1, wherein prior to switching on the first MOSFET transistor, the controller is further configured to maintain the first MOSFET transistor and the second MOSFET transistor in respective off states for an initial time period, such that current flows from a body diode of the first MOSFET transistor to the output node via the current limiter element.

3. The current limiter circuit of claim 1, wherein
an input terminal of the first MOSFET transistor is coupled to the input node;
an output terminal of the first MOSFET transistor is coupled to the input terminal of the second MOSFET transistor; and
an output terminal of the second MOSFET transistor is coupled to the output node.

4. The current limiter circuit of claim 3, wherein the current limiter element comprises a resistor connected in parallel with the input and output terminals of the second MOSFET transistor.

5. The current limiter circuit of claim 1,
wherein the controller comprises a controller input coupled to the output node; and
wherein the controller output is coupled to respective gate terminals of the first and second MOSFET transistors.

6. The current limiter circuit of claim 5, wherein the delay circuit comprises an RC delay element, said RC delay element comprising
a delay resistor coupled between the controller output and the gate terminal of the second MOSFET transistor; and
a capacitor coupled between the gate terminal of the second MOSFET transistor and the input terminal of the second MOSFET transistor.

7. The current limiter circuit of claim 1, wherein the time delay is a time period for the power supply capacitor to be sufficiently charged when current flows through the current limiter element.

8. The current limiter circuit of claim 1, wherein the first and second MOSFET transistors are PMOS transistors.

9. A method of controlling current between a power supply source at an input node of a current limiter circuit and a power supply capacitor of a power supply at an output node of the current limiter circuit, the method comprising, providing a first MOSFET transistor and a second MOSFET transistor coupled in series between the input node and the output node;
providing a controller comprising an output terminal for controlling the first and second MOSFET transistors;
providing a current limiter element coupled in parallel with the second MOSFET transistor;
providing a delay circuit for delaying switching on of the second MOSFET transistor for a time period after the first MOSFET transistor is switched on;
switching on the first MOSFET transistor during powering up of the power supply source, such that current flows between the input node and the output node via the current limiter element; and
switching on the second MOSFET transistor after the time period, such that current flows between the input node and the output node, bypassing the current limiter element.

10. The method of claim 9, further comprising, prior to switching on the first MOSFET transistor, maintaining the first MOSFET transistor and the second MOSFET transistor in respective off states for an initial time period, such that current flows from a body diode of the first MOSFET transistor to the output node via the current limiter element.

11. The method of claim 9, wherein the step of providing the first MOSFET transistor and the second MOSFET transistor comprises,
coupling an input terminal of the first MOSFET transistor to the input node;
coupling an output terminal of the first MOSFET transistor to the input terminal of the second MOSFET transistor; and
coupling an output terminal of the second MOSFET transistor to the output node.

12. The method of claim 11, wherein the step of providing the current limiter element comprises connecting a resistor in parallel with the input and output terminals of the second MOSFET transistor.

13. The method of claim 9, wherein the step of providing the controller comprises
coupling an input terminal of the controller to the output node; and
coupling the output terminal of the controller to respective gate terminals of the first and second MOSFET transistors.

14. The method of claim 13, wherein the step of providing the delay circuit comprises
providing a delay resistor coupled between the output terminal of the controller and the gate terminal of the second MOSFET transistor; and
providing a capacitor coupled between the gate terminal of the second MOSFET transistor and the input terminal of the second MOSFET transistor.

15. The method of claim 9, wherein the time delay is a time period for the power supply capacitor to be sufficiently charged when current flows through the current limiter element.

16. The method of claim 9, wherein the first and second MOSFET transistors are PMOS transistors.
